(19) United States
(12) Patent Application Publication
(10) Pub. No.: US 2001/0055355 A1
(43) Pub. Date: Dec. 27, 2001

(54) Clock recovery circuit

(75) Inventor: Koji Okamoto, Osaka (JP)

Correspondence Address: Jack Q. Lever, Jr., McDERMOTT, WILL & EMERY, 600 Thirteenth Street, N.W, Washington, DC, 20005-3096, US

(73) Assignee: MATSUSHITA ELECTRIC INDUSTRIAL CO., LTD.

(21) Appl. No.: 09/888,531

(22) Filed: Jun. 26, 2001

(30) Foreign Application Priority Data
Jun. 26, 2000 (JP) 2000-190493

(51) Int. Cl. H04L 7/00

(52) U.S. Cl. 375/355

(57) ABSTRACT

A cross detection part detects a zero-crossing point of a reproduction signal digitalized and a phase error estimation part uses the zero-crossing point of the reproduction signal for estimating a phase error thereof. At this time, a pattern detection part detects whether a variation pattern of the reproduction signal is a specified pattern (for example, a 3T pattern for the case of DVD disks) and controls a selection part to ensure that no phase error estimation value of low reliability is utilized for controlling of a PLL for clock recovery.

### BACKGROUND OF THE INVENTION

The present invention relates to a clock recovery circuit for recovering, from an input signal digitalized, a clock which synchronizes with the input signal.

In a data reproducing apparatus for data reproduction by decoding a data signal recorded on a recording medium such as an optical disk and a magnetic disk, a reproduction signal from the recording medium is identified as data, therefore necessitating recovery of a clock in synchronization with the reproduction signal from the reproduction signal.

For example, data, 8/16 modulated according to an RLL (2, 10) modulation code, are stored in a DVD disk. If the recording channel bit is T, then the pulse width of a reproduction data series falls in the 3T-11T range. Actual reproduction data is in the form of an analog waveform as shown in FIG. 8 owing to the MTF characteristic of an optical head. This analog waveform is subjected to sampling by an A/D converter for digitalization. Clock recovery from the reproduction signal thus digitalized is carried out.

As a method for recovery of a clock in synchronization with a reproduction signal when the output of an A/D converter is represented by the 2's complement, there is given a technique using the zero-crossing point of reproduction data. In such a technique, a phase error proportional to the sample value of the reproduction signal identified as a zero-crossing point is calculated and a PLL (phase locked loop) for clock recovery operates so that the phase error becomes zero.

Apart from the above, if characteristic degradation or defocus occurs in the optical head, this may result in reproduction signal degradation and misidentification of a zero-crossing point. For the case of DVD disks, such a misidentification is likely to take place at 3T in which the reproduction signal has its shortest pulse width (high frequency).

Referring to FIG. 9, there is illustrated an example of a degraded reproduction signal in the optical disk apparatus. According to the example of FIG. 9, in spite of the fact that it is a sample value Zt (cycle 79) that must be distinguished as an actual zero-crossing point when the variation pattern of a reproduction signal is a 3T pattern, the cross detection part of the conventional clock recovery circuit will misidentify a sample value Z (cycle 80) next to the sample value Zt as a zero-crossing point. When the zero-crossing point of a reproduction signal is misidentified in the way as described above, the direction of phase error is taken in a wrong direction. As a result, the lock of the PLL for clock recovery is unlocked.

### SUMMARY OF THE INVENTION

Accordingly, an object of the present invention is to provide protection against unlocking of the PLL by preventing a phase error misdetected in the clock recovery circuit from being utilized.

In order to achieve the above object, a clock recovery circuit according to the present invention employs an arrangement in which, when it becomes clear that a variation pattern of the input signal indicates a specified pattern (for example, a 3T pattern for DVD disks), for example, the reliability of detecting a zero-crossing point is considered low and no phase error estimated will be utilized for PLL control.

More specifically, the present invention provides a clock recovery circuit comprising a clock generation part for generating a clock signal, a phase error detection part for detecting the phase error of the input signal with respect to the clock signal, and a control part for controlling, based on an output of the phase error detection part, an oscillation frequency of the clock generation part so that the phase error becomes zero, wherein the phase error detection part includes a cross detection part for generating a timing signal representative of a point at which the input signal crosses a preset value, a phase error estimation part for estimating, based on the timing signal, the phase error of the input signal with respect to the clock signal, a pattern detection part for detecting the variation pattern of the input signal, and a selection part for selecting, according to the detected variation pattern, whether the estimated phase error is output to the control part.

### BRIEF DESCRIPTION OF THE DRAWINGS

FIG. 1 is a block diagram showing an example of an arrangement of a reproduction system signal processing circuit in an optical disk apparatus making utilization of a clock recovery circuit according to the present invention.

FIG. 2 is a block diagram showing an example of an arrangement of the clock recovery circuit in FIG. 1.

FIG. 3 is a circuit diagram showing an example of an arrangement of the pattern detection part in FIG. 2.

FIG. 4 is a conceptual diagram for providing the description of a principle of the operation of the pattern detection part in FIG. 2.

FIG. 5 is a circuit diagram showing an example of an arrangement of a pattern detection part to which the principle of FIG. 4 is applied.

FIG. 6 is a conceptual diagram for providing the description of another principle of the operation of the pattern detection part in FIG. 2.

FIG. 7 is a circuit diagram showing an example of an arrangement of a pattern detection part to which the principle of FIG. 6 is applied

FIG. 8 is a waveform diagram showing examples of recorded data and a reproduction signal in an optical disk.

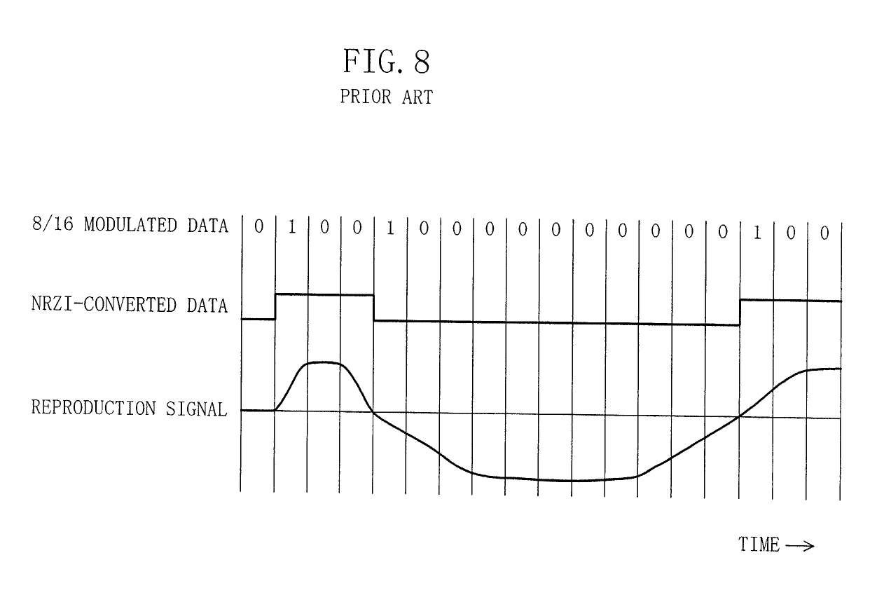

FIG. 9 is a waveform diagram showing an example of a reproduction signal degraded.

### DETAILED DESCRIPTION OF THE INVENTION

Hereinafter, examples of applications of the present invention to a clock recovery circuit in a DVD disk reproduction system will be described.

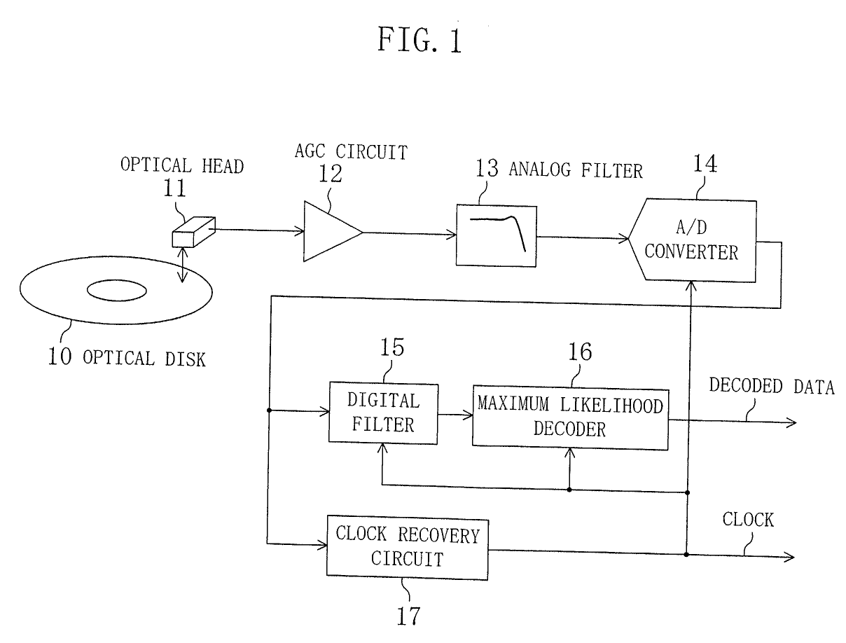

Referring to FIG. 1, there is shown an example of a reproduction system signal processing circuit in an optical disk apparatus making utilization of a clock recovery circuit according to the present invention. Shown in FIG. 1 are an optical (DVD) disk 10, an optical head 11, an AGC circuit 12 for amplification correction of the reproduction signal, an analog filter 13, an A/D converter 14, a digital filter 15 for waveform correction, a maximum likelihood decoder 16, and a clock recovery circuit 17 according to the present invention.

With the arrangement of FIG. 1, the optical disk 10 is illuminated with reproduction light from the optical head 11. While causing the reproduction light to trace a pit string formed on the surface of the optical disk 10, the optical head 11 detects a ray of reflected light. Reflected light is shifted in its phase depending on the presence or absence of pits. Accordingly, the optical head 11 obtains light, whose brightness changes depending on the presence or absence of pits, by superimposition of the reflected light and the reproduction light, wherein the light thus obtained is converted by a photodetector into an electric signal. A reproduction signal obtained by the optical head 11 is amplified by the AGC circuit 12 and then waveform equalized by the analog filter 13. The output of the analog filter 13 is fed to the A/D converter 14. The A/D converter 14 digitalizes an analog signal supplied. The reproduction signal thus digitalized is subjected to waveform correction in the digital filter 15 so that it exhibits a desired reproduction characteristic and thereafter converted into decoded data by the maximum likelihood decoder 16. Further, the reproduction signal digitalized in the A/D converter 14 is input also to the clock recovery circuit 17. The clock recovery circuit 17 recovers, from the input signal, a clock which synchronizes with the input signal. An output clock (a recovery clock) from the clock recovery circuit 17 serves as a sampling clock for digitalization in the A/D converter 14 and also as a system clock for digital components such as the digital filter 15 and the maximum likelihood decoder 16.

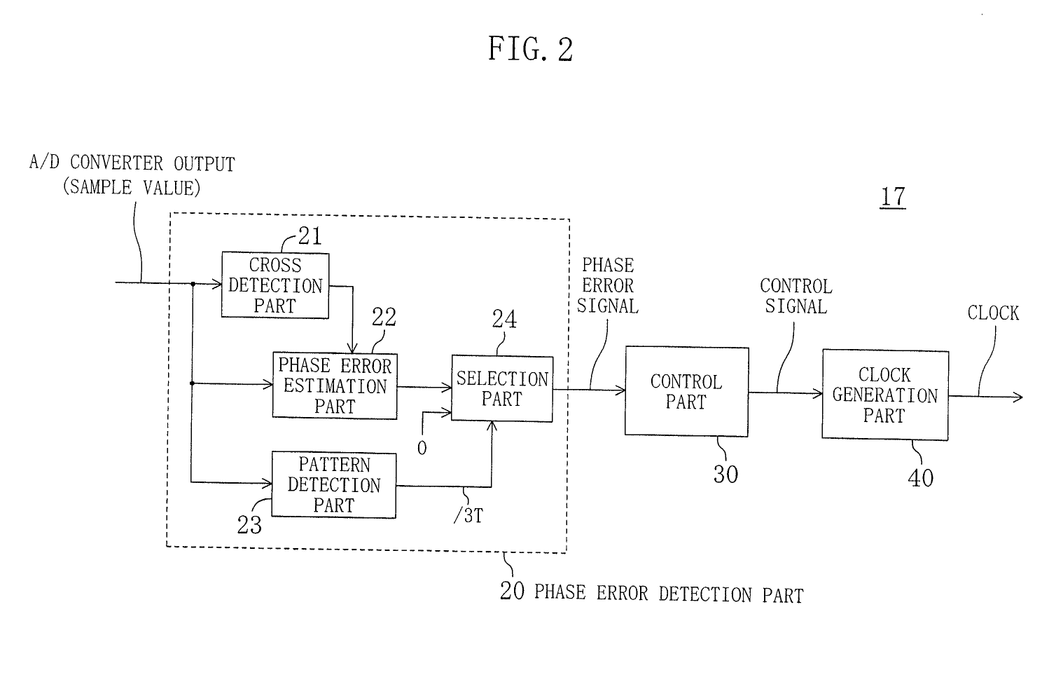

Referring to FIG. 2, there is shown an example of an arrangement of the clock recovery circuit 17 in FIG. 1. Shown in FIG. 2 are a phase error detection part 20, a control part 30, and a clock generation part 40. The clock generation part 40 generates a frequency-variable clock signal so that a recovery clock is supplied. The phase error detection part 20 receives, as its input signal, an output sample value from the A/D converter 14, i.e., a digitalized reproduction signal (hereinafter, referred to just as the reproduction signal) and detects the phase error of the reproduction signal with respect to the recovery clock. Based on the result of the phase error detection by the phase error detection part 20, the control part 30 controls the oscillation frequency of the clock generation part 40 so that the phase error becomes zero.

Included in the phase error detection part 20 are a cross detection part 21, a phase error estimation part 22, a pattern detection part 23, and a selection part 24. The cross detection part 21 detects a point at which the reproduction signal zero-crosses. More specifically, at the time when zero-crossing is detected, a signal of Hi (HIGH) level as a timing signal is output from the cross detection part 21 for only one cycle. The phase error estimation part 22 estimates, from a reproduction signal when a Hi-level timing signal is output from the cross detection part 21, the phase error of the reproduction signal with respect to the recovery clock. The pattern detection part 23 is a circuit block for detecting the variation pattern of a reproduction signal. Here, the description has been made in terms of a clock recovery circuit in a DVD-disk reproduction system and the pattern detection part 23 in FIG. 2 is therefore intended for detection of whether the variation pattern of a reproduction signal is a 3T pattern. Further, suppose that a variation pattern detection signal /3T that is output from the pattern detection part 23 indicates a Lo (LOW) level when a 3T pattern is detected, whereas it indicates a Hi level when other than the 3T pattern is detected. The selection part 24 is a circuit block which selects the result of the phase error estimation if the variation pattern detection signal /3T is at Hi level. On the other hand, zero is selected if the variation pattern detection signal /3T is at Lo level. Then, the selection part 24 outputs a phase error detection signal to the control part 30.

That is, in the clock recovery circuit 17 of FIG. 2, if it becomes clear that the variation pattern of the reproduction signal indicates a 3T pattern, the reliability of detection of the zero-crossing point is considered low and no phase error estimation value will be utilized for PLL control. This guarantees that the clock recovery circuit 17 operates stably.

Hereinafter, first to third arrangement examples of the pattern detection part 23 in FIG. 2 will be explained one after another.

### FIRST ARRANGEMENT EXAMPLE

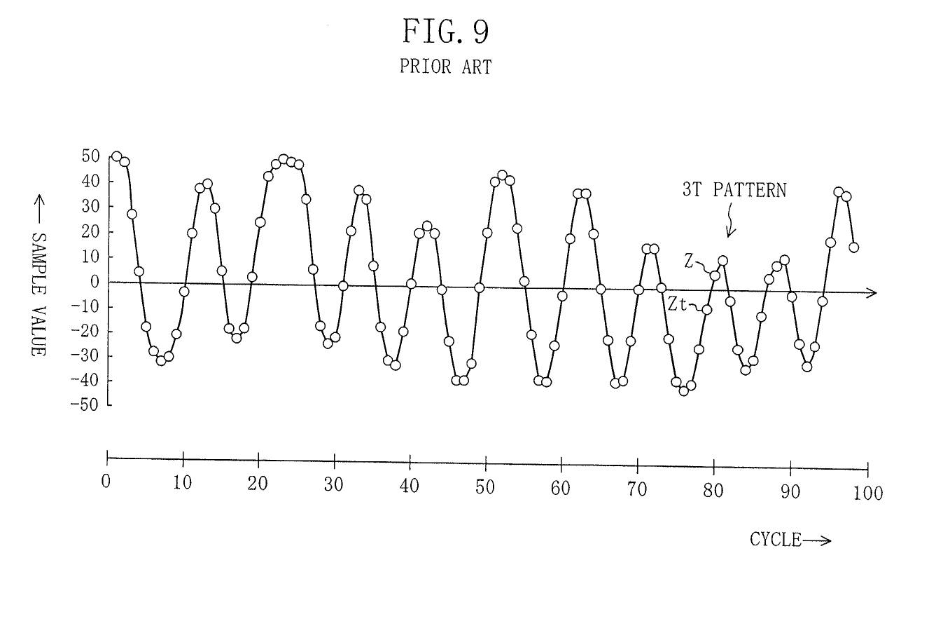

It is seen from FIG. 9 that the number of consecutive positive sample values (cycles 80 and 81) becomes extremely reduced in a 3T pattern in which conventional misidentification of a zero-crossing point occurs. The same is true for the case that the number of consecutive negative sample values becomes extremely reduced.

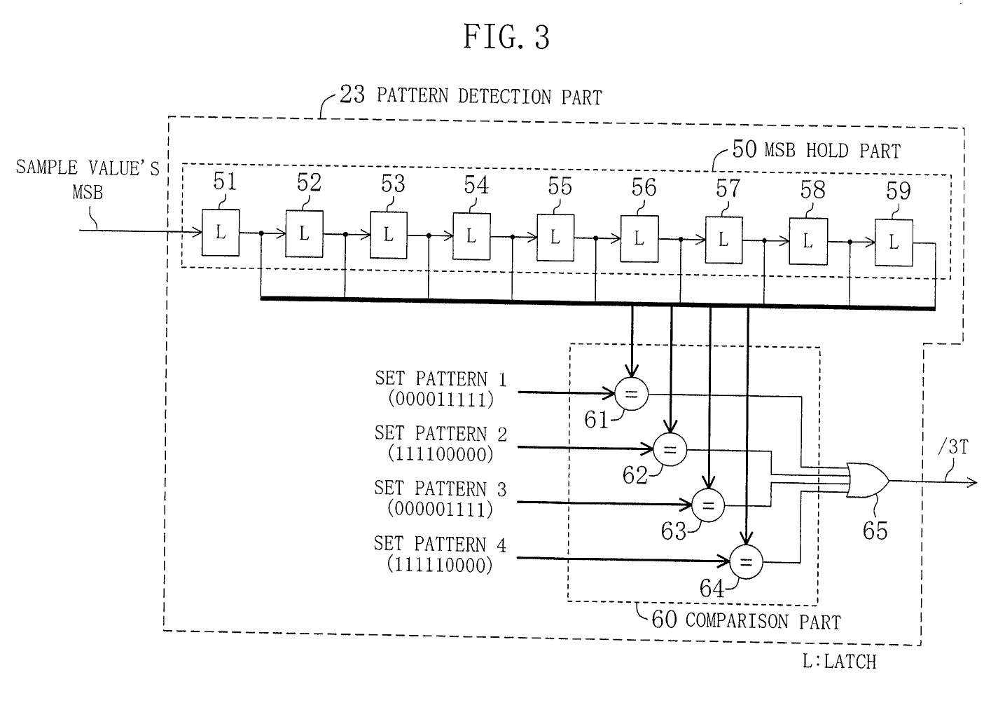

The first arrangement example of the pattern detection part 23 shown in FIG. 3 detects, based on such a principle, the presence or absence of a 3T pattern. Shown in FIG. 3 are an MSB hold part 50, a comparison part 60, and a logical circuit part 65. The MSB hold part 50 is made up of nine 1-bit latches 51-59 and holds the respective most significant bits of sample values given (i.e., the sign bits in 2's complement representation) as time series data. The comparison part 60 is made up of four 9-bit comparators 61-64 and compares data items stored in the MSB hold part 50 with preset variation patterns. Here, these four preset patterns are “000011111”, “111100000”, “000001111” and “111110000”. This is based on the viewpoint that there are either at least four consecutive positive sample values or at least four consecutive negative sample values if the variation pattern of the reproduction signal is other than the 3T pattern. That is, if the variation pattern of the reproduction signal is a 3T pattern, no agreement is established in any one of the four 9-bit comparators 61-64 and all of the outputs of these comparators 61-64 are made LOW. The logical circuit part 65 comprises a 4-input OR gate for generation of the variation pattern detection signal /3T from the outputs of the comparators 61-64. In other words, the variation pattern detection signal /3T is made LOW if the variation pattern is a 3T pattern.

### SECOND ARRANGEMENT EXAMPLE

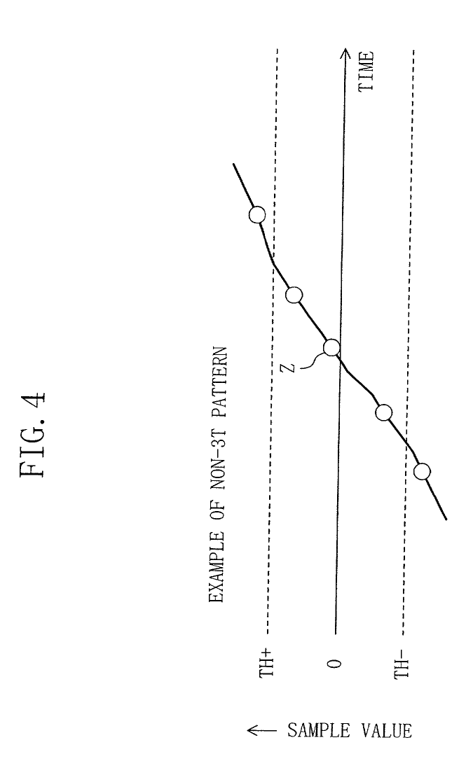

Referring to FIG. 4, there is shown another principle of the operation of the pattern detection part 23 in FIG. 2. That is, according to this principle, if the variation pattern of the reproduction signal is other than the 3T pattern, the absolute values of sample values, one of which is ahead by two sample positions from a sample value Z distinguished as a zero-crossing point and the other of which is behind by two sample positions from the sample value Z, are greater than the absolute values of preset threshold values (TH+ on the +side and TH− on the −side) and have different signs.

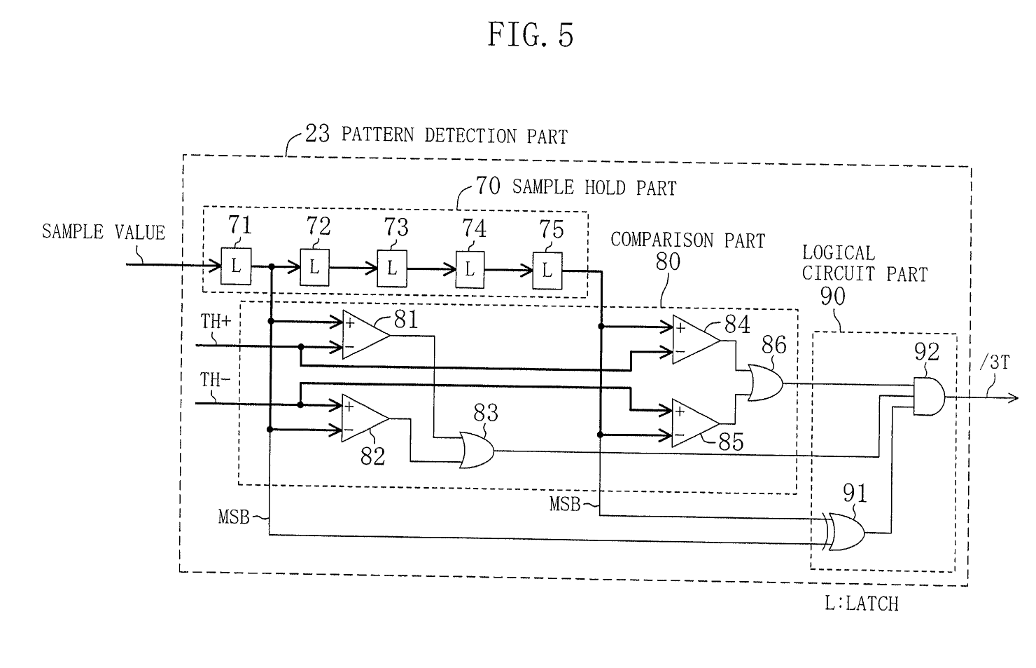

The second arrangement example of the pattern detection part 23 shown in FIG. 5 employs such a principle for detecting the presence or absence of a 3T pattern. Shown in FIG. 5 are a sample hold part 70, a comparison part 80, and a logical circuit part 90. The sample hold part 70 is made up of five multibit latches 71-75 and holds sample values given as time series data. The comparison part 80 is made up of four multibit comparators 81, 82, 84, and 85 and two 2-input OR gates 83 an 86. In the comparators 81 and 82 and the OR gate 83, the data item stored in the first-stage latch 71 of the sample hold part 70 is compared in size with the threshold value TH+ and with the threshold value TH− and a signal of Hi level is supplied whenever the first-stage latch data is greater in absolute value than the threshold values. In the comparators 84 and 85 and the OR gate 86, the data item stored in the last-stage latch 75 of the sample hold part 70 is compared in size with the threshold value TH+ and with the threshold value TH− and a signal of Hi level is supplied whenever the last-stage latch data is greater in absolute value than the threshold values. The logical circuit part 90 is made up of an exclusive OR gate 91 and a 3-input AND gate 92 for generation of the variation pattern detection signal /3T. That is, if the outputs of the two 2-input OR gates 83 and 86 in the comparison part 80 are both at Hi level and, in addition, if the data stored in the first- and last-stage latches 71 and 75 in the sample hold part 70 differ in sign from each other, this indicates other than the 3T pattern as shown in FIG. 4, so that the variation pattern detection signal /3T is made HIGH. On the other hand, if the variation pattern is a 3T pattern, then the variation pattern detection signal /3T is made LOW.

Further, as the threshold values TH+ and TH− in such a case, the threshold values of a Viterbi decoder in a reproduction system of a conventional optical disk can be used. Of the data items stored in the sample hold part 70, three or more data items may be compared in size with preset threshold values.

### THIRD ARRANGEMENT EXAMPLE

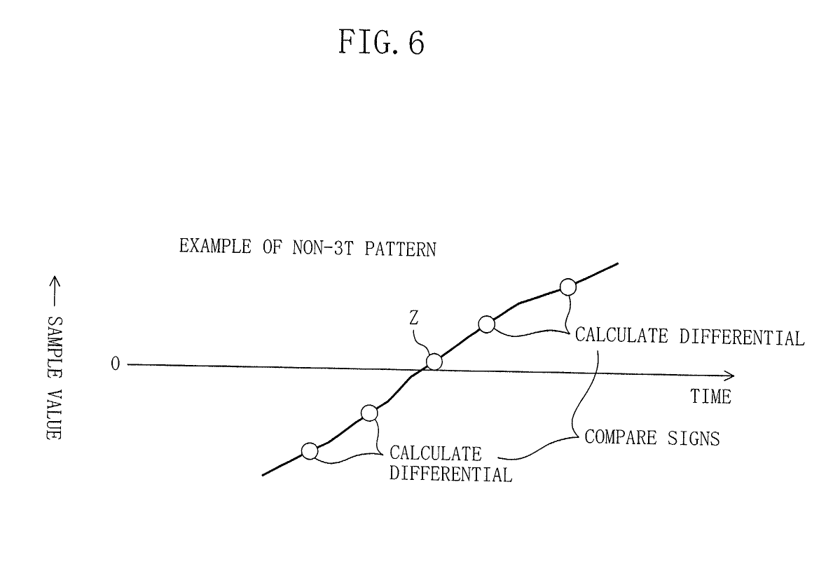

Referring to FIG. 6, there is shown still another principle of the operation of the pattern detection part 23 in FIG. 2. That is, according to this operation, if the variation pattern is other than the 3T pattern, the differential value of two preceding samples and the differential value of two following samples with respect to the sample value Z distinguished as a zero-crossing point have the same sign.

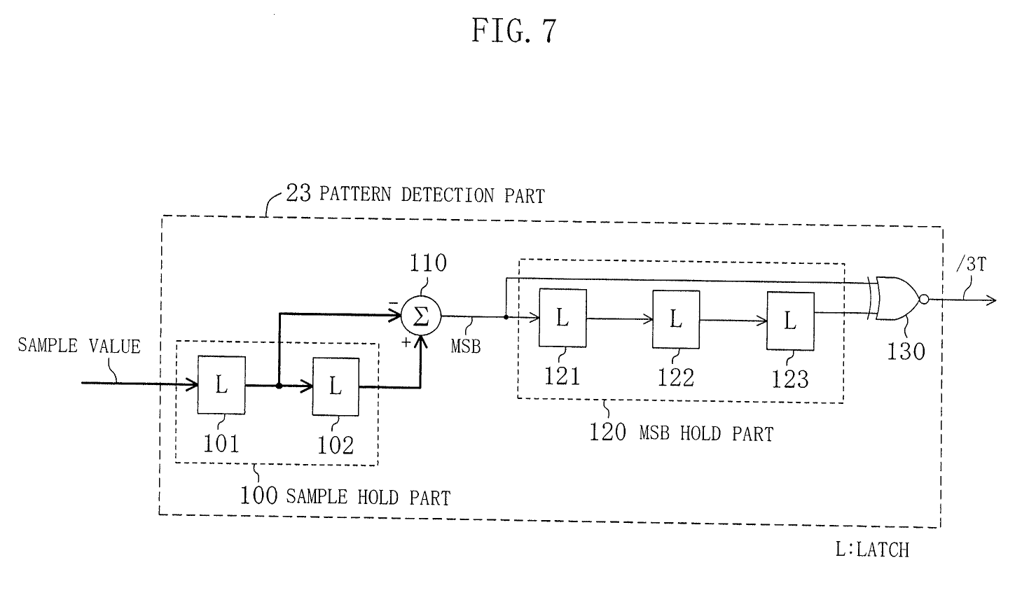

The third arrangement example of the pattern detection part 23 shown in FIG. 7 employs this principle and detects the presence or absence of a 3T pattern. Shown in FIG. 7 are a sample hold part 100, a subtraction part 110, an MSB hold part 120, and a logical circuit part 130. The sample hold part 100 is made up of two multibit latches 101 and 102 and holds sample values given as time series data. The subtraction part 110 sequentially calculates the differential of two consecutive data items stored in the sample hold part 100. The MSB hold part 120 is made up of three 1-bit latches 121-123 and holds the respective most significant bits (the sign bits) of the serial output of the subtraction part 110 as time series data. The logical circuit part 130 comprises an exclusive NOR gate so that the variation pattern detection signal /3T is formed of the I/O data items of the MSB hold part 120. That is, if the output of the subtraction part 110 and the output of the last-stage latch 123 of the MSB hold part have the same sign, this indicates other than the 3T pattern as shown in FIG. 6. Accordingly, the variation pattern detection signal /3T is made HIGH. On the other hand, if the variation pattern is a 3T pattern, then the variation pattern detection signal /3T is made LOW.

The examples of the applications of the present invention to a clock recovery circuit in the reproduction system of the DVD disk have been explained. However, the present invention is not limited to these applications. Further, if the input signal of the clock recovery circuit is a digital signal represented by other than the 21's complement representation, a phase error is detected based on a point at which the input signal crosses a preset value other than zero.

What is claimed is:

1. A clock recovery circuit for recovery of a clock from an input signal digitalized, said clock being in synchronization with said input signal,
said clock recovery circuit comprising:
a clock generation part for generating a clock signal;
a phase error detection part for detecting a phase error of said input signal with respect to said clock signal; and
a control part for controlling, based on an output of said phase error detection part, an oscillation frequency of said clock generation part so that said phase error becomes zero;
said phase error detection part including:
a cross detection part for generating a timing signal representative of a point at which said input signal crosses a preset value;
a phase error estimation part for estimating, based on said timing signal, said phase error of said input signal with respect to said clock signal;
a pattern detection part for detecting a variation pattern of said input signal; and
a selection part for selecting, according to said detected variation pattern, whether said estimated phase error is output to said control part.

2. The clock recovery circuit of claim 1,
said pattern detection part including:
a hold part for holding said input signal as time series data;
a comparison part for comparing data items stored in said hold part with preset variation patterns; and
a logical circuit part for controlling, when it becomes clear from a result of said comparison that the variation pattern of said input signal indicates a specified pattern, said selection part so that said estimated phase error is not output to said control part.

3. The clock recovery circuit of claim 1,
said pattern detection part including:
a hold part for holding said input signal as time series data;
a comparison part for comparing in size at least two items of data stored in said hold part with preset threshold values; and
a logical circuit part for controlling, when it becomes clear from said at least two data items and from a result of said comparison that the variation pattern of said input signal indicates a specified pattern, said selection part so that said estimated phase error is not output to said control part.

4. The clock recovery circuit of claim 1, said pattern detection part including:
a first hold part for holding said input signal as time series data;
a subtraction part for sequentially calculating a differential of two consecutive data items stored in said first hold part;
a second hold part for holding a serial output of said subtraction part as time series data; and
a logical circuit part for controlling, when it becomes clear from the serial output of said subtraction part and from at least one item of data stored in said second hold part that the variation pattern of said input signal indicates a specified pattern, said selection part so that said estimated phase error is not output to said control part.
